(19) United States
(12) Patent Application Publication
(10) Pub. No.: US 2012/0117594 A1
(43) Pub. Date: May 10, 2012

(54) METHOD AND APPARATUS FOR PROVIDING CONVERGED SOCIAL BROADCASTING SERVICE

(75) Inventors: Bong Ho LEE, Daejeon-si (KR); Gwang Soon LEE, Daejeon-si (KR); Hyun LEE, Daejeon-si (KR); Jae Hwui BAE, Daejeon-si (KR); Kwang Yong KIM, Daejeon-si (KR); Nam Ho HUR, Daejeon-si (KR); Soo In LEE, Daejeon-si (KR); Jae Wook LEE, Seoul (KR)

(73) Assignees: NET & TV, INC., Seoul (KR); Electronics and Telecommunications Research Institute, Daejeon (KR)

(21) Appl. No.: 13/290,042

(22) Filed: Nov. 4, 2011

(30) Foreign Application Priority Data
Nov. 5, 2010 (KR) 10-2010-0110034
Nov. 4, 2011 (KR) 10-2011-0114830

(51) Int. Cl. H04N 21/458

(52) U.S. Cl. 725/34

(57) ABSTRACT

A method for providing social broadcasting services by a broadcasting station is registered. The method for providing social broadcasting services includes receiving from a social network server like function related information triggering transmission of an interest indicator indicating that a user of a user equipment has an interest in broadcasting programs provided by a content provider; and transmitting both of the broadcasting programs and additional data including the like function related information to the user equipment. By the configuration, the exemplary embodiments of the present invention can share the personal's opinion and thoughts and the additional data associated with the corresponding programs through the social circle while the user viewing the broadcasting programs in real time during the movement.

### CROSS-REFERENCE TO RELATED APPLICATIONS

This application claims the benefit of priority of Korean Patent Application No. 10-2010-0110034 filed on Nov. 5, 2010, and Korean Patent Application No. 10-2011-0114830 filed on Nov. 4, 2011, all of which are incorporated by reference in their entirety herein.

### BACKGROUND OF THE INVENTION

1. Field of the Invention

The present invention relates to a broadcasting service, and more particularly, to a technology of providing social broadcasting services based on a converged system of a broadcasting network and a communication network.

2. Related Art

Digital multimedia broadcast (DMB) that is representative mobile broadcasting in Korea still has a problem in a business such as profitability, or the like, even though the DMB stably secures user equipments.

The term social has been used in various fields such as a social media, a social network, a social web, a social commerce, a social networking service (SNS), a social game, or the like. The social configures collective intelligence by gathering various opinions, thoughts, assertions, information, or the like, and explosively distributing them and sharing them in real time based on the relation between the individual users and therefore, may be referred to as a relation-oriented concept creating various types of new values according to a result of the interaction.

An arrival distance of broadcasting contents may be shortened by applying a social concept to the broadcasting service. Various social media platforms provide an application programming interface (API) that may be linked with the corresponding platform only by simply clicking icons.

FIGS. 1 and 2 show a twitter that is an example of a social media.

Referring to FIG. 1, if user A uploads tweets that are a kind of messages registered on his/her own twitter web page, other users (referred to as followers) following the user A may view the uploaded tweets. In addition, if user B that is one of the followers to of the user A uploads the tweet uploaded by the user A to his/her own twitter web page (referred to as retweet), followers of the user B can view the retweet of the user B. A distribution structure of the twitter transferring the tweet by the user A to the followers of the user B is a complicated and powerful structure. In this case, an accumulated sum of each follower is a message transfer target. A twitter has a half-real time communication structure through a device, such as a smart phone.

FIG. 2 shows a structure of a following relation of the twitter. In this case, each number 1, 2, 3, . . . , N or S represents a potential exposure frequency of a message and each pattern represents a message transferring process. An individual retweet and follower structure exhibits a broadcasting effect. Overlapping the following exhibits the rapid broadcasting effect even in the case of the half-real time transmission rather than the real-time transmission.

The social media service such as the twitter that is a short text based service has service characteristics very similar to a broadcasting media service that is an image content based service. First, the broadcasting media and the social media such as the twitter have real-time capability. Second, a concept of follow and unfollow of the twitter is similar to performing a channel role of the broadcasting media. That is, following the followers is similar to allowing a broadcasting viewer to select a single channel and view the selected channel.

The retweet function of the twitter has a rapid propagation speed of information in real time. The retweet means that the followers of the followers can view initially uploaded tweets when the followers retweet the tweets uploaded by the user.

A like function provided from a facebook that is another social media service simply and intuitively provides a link between the user and the page. To the present, the social media user such as the twitter or the facebook has been very rapidly increased. The distribution of the smart phone promotes the diffusion of the social media. Conversely, the diffusion of the social media acts as an affirmative element to distribute the smart phone.

The advertising value of the broadcasting media has been recognized by a program audience rating and the advertising value of newspaper/magazine has been recognized by a subscribing rate. In view of a distribution channel, newspaper provides information through its own corporate online site, but inflowing traffic through portals such as Naver/Daum gets an absolute majority. However, interesting news shares in real time through the twitter and the facebook in recent years. Exponential propagation through retransmission rather than the linear type propagation can be implemented.

That is, how more easily and rapidly the contents are transferred to the user and the user views, reads, listens the contents is a target of the content provider or broadcasters. Therefore, a need exists for the content provider or the broadcaster to positively use the social media. Among the social media service functions, the user's recommendation function may be used. The there is a need to appropriately provide social broadcast services capable of providing advantages such as profits and user-friendly high-quality services to the provider and the viewer.

### SUMMARY OF THE INVENTION

The present invention provides a converged social broadcasting service using a social circle that is a broadcasting content centered viewer community.

The present invention also provides a method and an apparatus for providing services in a type of linking a social service with a broadcasting program.

In an aspect, there is provided a method for providing social broadcasting services, including: receiving from a social network server like function related information triggering transmission of an interest indicator indicating that a user of a user equipment has an interest in broadcasting programs provided by a content provider; and transmitting both of the broadcasting programs and additional data including the like function related information to the user equipment.

The broadcasting programs may be transmitted to the user equipment through a video stream and the additional data may be transmitted to the user equipment through a binary format for scene (BIFS) stream.

A signal of the video stream and a signal of the BIFS stream may be synchronized with each other frame by frame.

The like function related information may be information set so as to position in an icon form buttons performing the like function on a screen of the user equipment to which the broadcasting programs are provided and trigger the transmission of the interest indicator when the icons are clicked or touched.

The interest indicator may indicate so as to allow the user equipment to run social application of the user equipment.

The social application may be facebook application so as to share a web page including information regarding the broadcasting programs with other users.

In another aspect, there is provided a method for providing social broadcasting services, including: receiving from a broadcasting station additional data including like function related information triggering transmission of an interest indicator indicating that a user of a user equipment has an interest in broadcasting programs provided by a content provider, together with the broadcasting programs; running social application of the user equipment when the transmission of the interest indicator is triggered; and linking a web page of the content provider with a web page of the user by using the social application.

The social application may be facebook application so as to share the web page including information regarding the broadcasting program with other users and the web page of the content provider and the web page of the user may each be the facebook page of the content provider and the facebook page of the user.

In another aspect, there is provided a method for providing social broadcasting services, including: receiving from a social network server a writing indicator indicating that a message registered using social application by a user of a user equipment is a message regarding broadcasting programs provided by a content provider; registering a message using the social application; and transmitting both of additional data including the writing indicator and the broadcasting programs to the user equipment.

The social application may be twitter application so as to share a message registered by the user with other users, and the message registered by the user may be a tweet.

### BRIEF DESCRIPTION OF THE DRAWINGS

FIGS. 1 and 2 show a twitter that is an example of a social media.

FIG. 3 shows a system configuration diagram of a broadcasting communication converged mobile broadcasting service to which the present invention is applied.

FIGS. 4 to 6 show an example of implementing a DMB/mobile broadcasting business model.

FIG. 7 shows an example of an OHTV system structure.

FIG. 8 shows an example of a platform provided by a method for providing social mobile broadcasting services.

FIG. 9 is a flow chart showing an example of the social mobile broadcasting service according to the exemplary embodiment of the present invention.

FIG. 10 is a flow chart showing another example of social mobile broadcasting services according to another exemplary embodiment of the present invention.

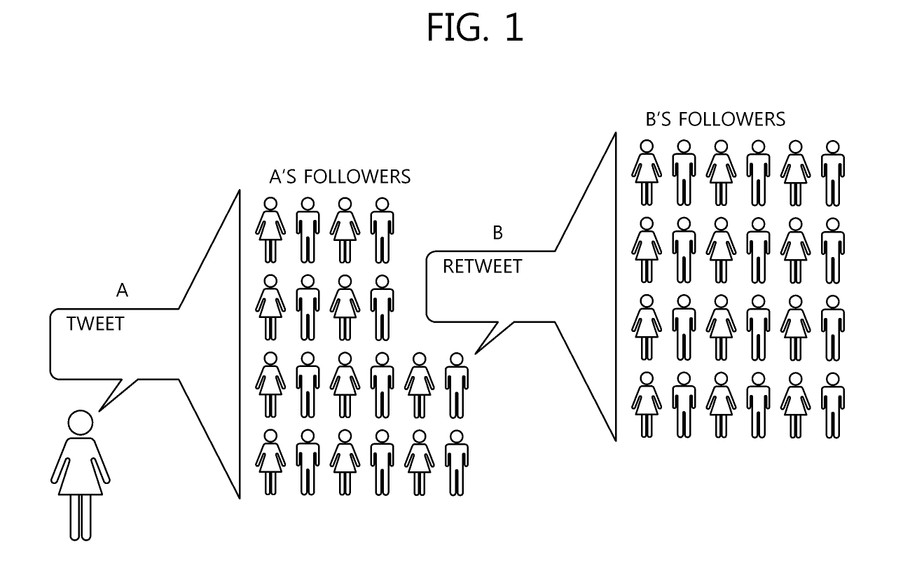

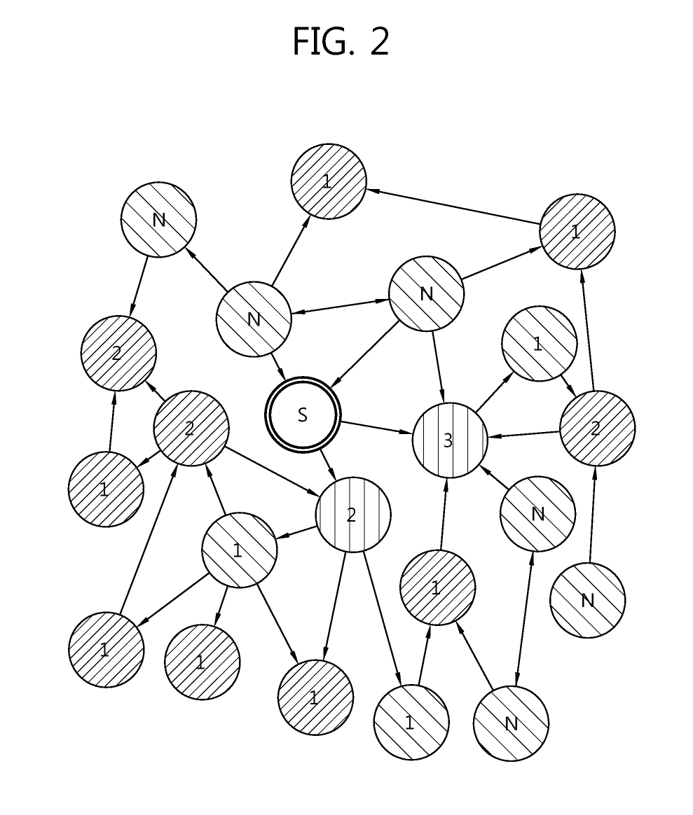

### DESCRIPTION OF EXEMPLARY EMBODIMENTS

Hereinafter, exemplary embodiments of the present invention will be described in detail with reference to the accompanying drawings so that those skilled in the art may easily practice the present invention. However, the present invention may be modified in various different ways and is not limited to exemplary embodiments disclosed below. In addition, portions unrelated to the present invention has been omitted in the accompanying drawing in order to clearly disclose the present invention, and like or similar reference numerals designate like or similar components.

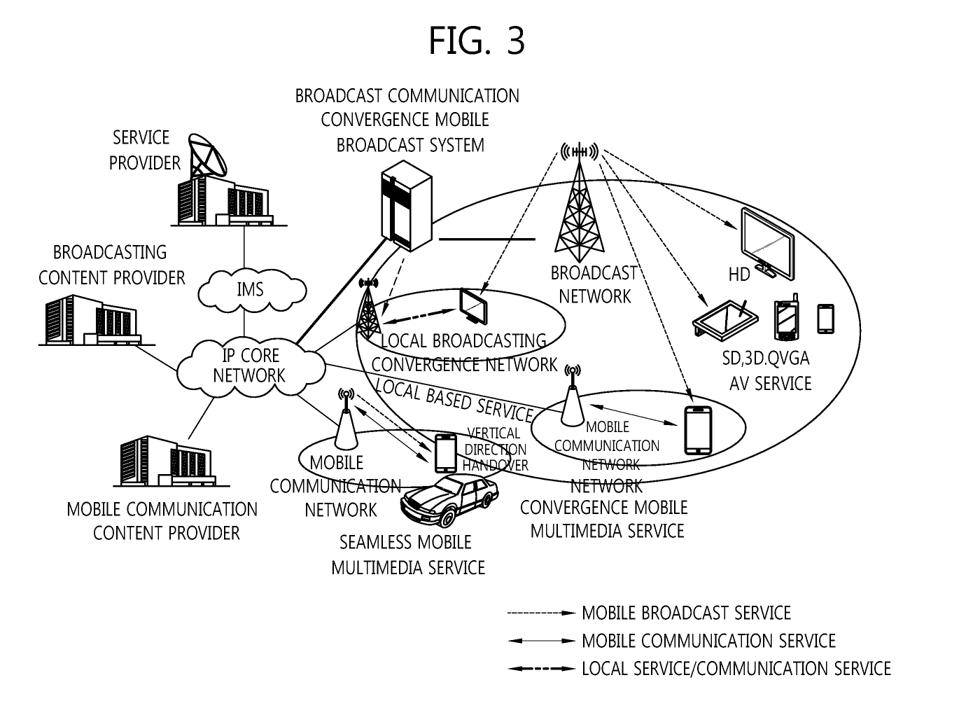

FIG. 3 shows a system configuration diagram of a broadcasting communication converged mobile broadcasting service to which the present invention is applied.

Referring to FIG. 3, a broadcasting communication converged mobile broadcasting system is linked with a mobile communication network to provide various types of services such as a mobile broadcasting service, a mobile communication service, and a local broadcasting/communication service. In this case, a service provider, a broadcasting content provider, or a mobile communication content provider may provide services through a local broadcasting converged network or a mobile communication network based on an IP core network. This is referred to as a broadcasting communication convergence mobile multimedia service.

Unlike the existing broadcasting system, a seamless mobile multimedia broadcasting service may be provided by being converged with the mobile communication network. When the mobile communication network serves as an assist network of the broadcasting, the user can continuously view programs (or contents), which are being viewed by the user, at all the places through a vertical directional handover of the mobile broadcasting service and the mobile communication service. For example, the user may use a smart phone to receive services while walking or receive services while driving using a navigation of a car, or the like When the broadcasting network is linked with the mobile communication network, data to be commonly transferred to the viewer may be transmitted through the broadcasting network at a relatively low cost and user unique data may be individually transmitted using the mobile communication network.

Meanwhile, the broadcasting communication converged mobile broadcasting system is a type in which a broadcasting (for example, DMB) receiving function and a mobile communication function are integrated in view of the user equipment and is a type activating a service in which the broadcasting transmission function and the communication platform are linked with each other High definition (HD), standard definition (SD), three dimensional (3D), quarter video graphic array (QVGA), or audio video (AV) services are provided through the broadcasting network, but a simple uni-directional video service and a data service of a type such as a transport protocol experts group (TPEG) has a limitation in performing a function as a continuous interest of viewers and mobile broadcasting.

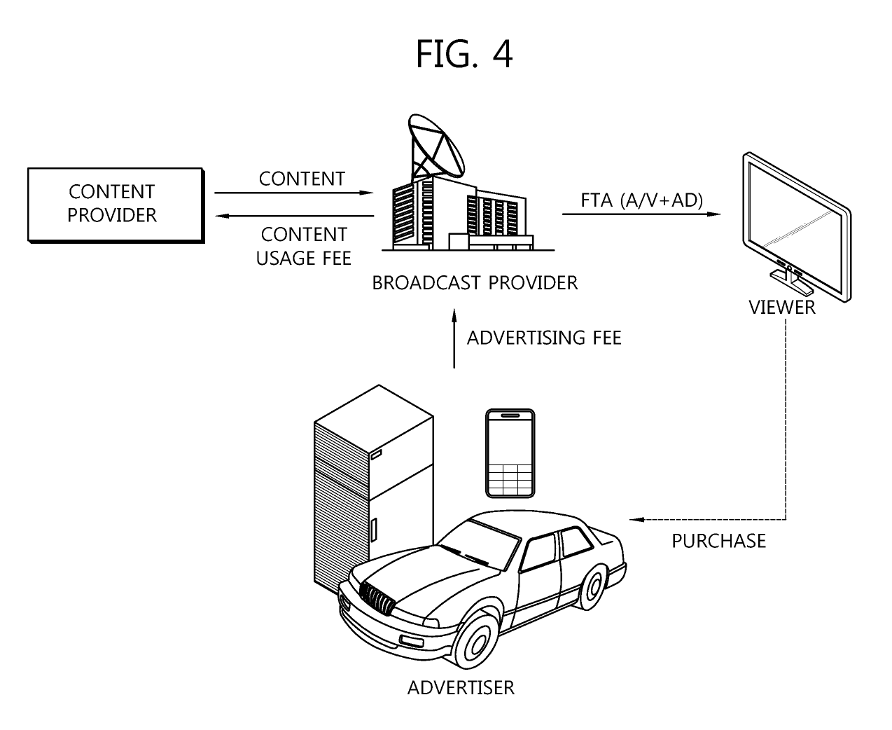

FIGS. 4 to 6 show an example of implementing a DMB/mobile broadcasting business model.

FIG. 4 shows a free service business model based on an advertisement of the DMB. The free service business model is a model creating profits through advertising attraction.

Referring to FIG. 4, a content provider provides contents to a broadcaster (broadcasting station) and receives a content usage fee. The broadcaster provides FTA including contents (audio/video (A/V)) and an advertisement (AD) to the viewer and receives an advertising fee from an advertiser. The advertiser may provide an advertisement so as to allowing a viewer (or user) to purchase an article, instead of paying the advertising fee to the broadcaster. The viewer/user may use the contents free of charge, instead of receiving the advertisement. In the advertisement based free service business model of the DMB, the advertiser needs to tune the advertising cost to requirements of the broadcaster well.

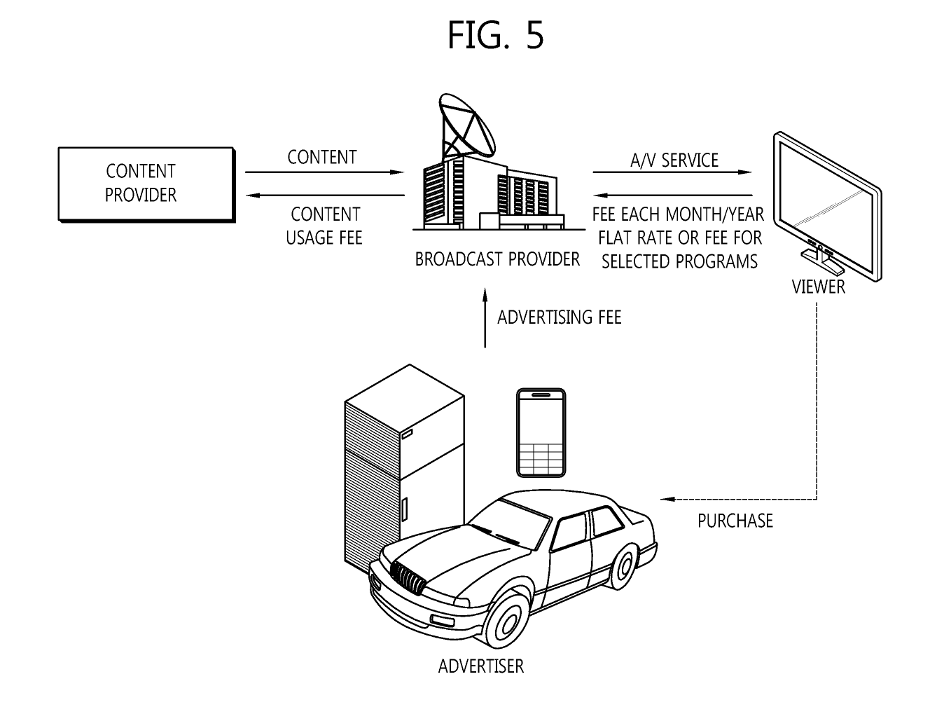

FIG. 5 shows a flat rate (or pay per view) service based business model of the DMB. This model is a business model that may be performed in a satellite DMB.

Referring to FIG. 5, the content provider provides the contents to the broadcaster and receives the content fee. The broadcaster provides the contents to the viewer and receives an audience fee for each viewing program from the viewer or receives a flat rate pay per view defined for each predetermined period (month, year, or the like). In this case, the advertisement may be selectively or partially received. The advertiser may provide the advertisement so as to allow the viewer to purchase an article, instead of paying the advertising fee to the broadcaster. The viewer may reject the advertisement viewing, instead of using the contents with fee.

The broadcaster may secure a periodic profit a predetermined level and does not facilitate the charged subscriber. The model is similar to the business model of a cable broadcaster such as a cable.

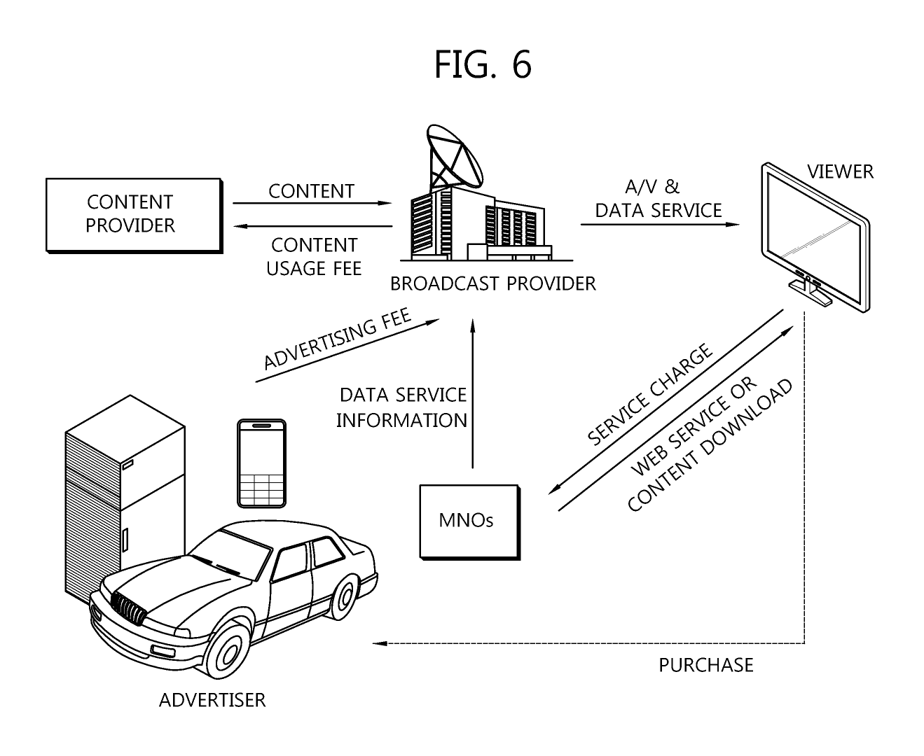

FIG. 6 shows a two-way data service based business model of the DMB.

Referring to FIG. 6, the two-way data service based business model of the DMB activates the data services based on the free broadcasting service to provide wireless Internet, short message service (SMS), data traffic, and additional advertising service.

The contents provider provides content to the broadcaster and receives the content fee. The broadcasting provider may provide the contents to the viewer and may also provide the data service. The advertiser may allow the broadcaster to provide advertisement to the viewer so as for the viewer to purchase an article, instead of paying an advertising fee to the broadcaster. Mobile network operators (MNO) such as SK telecom, KT, LG telecom, or the like, provide data service information to a viewer through the broadcaster or directly provides web services or content download services to the viewer and the viewer pays a service fee to the mobile network operators.

With the increase in a smart phone market, the smart phone is developed to a structure that may be converged with various services and a terrestrial DMB needs to activate characteristics of the mobile broadcasting to provide a new profit model through two-way services in addition to an advertising profit model so as to provide differentiated services.

The broadcaster can provide two-way services by using a moving picture experts group (MPEG) binary format for scene (BIFS) technology. The MPEG BIFS (hereinafter, referred to as BIFS) means a binary type of representation engine framework capable of implementing two-dimensional and three-dimensional graphics in a MPEG-4 standard and is a scene technology for freely representing various multimedia configured in an object unit and interacting with the users. The MPEG BIFS uses a binary technology rather than a text based technology, so as to correct and supplement a virtual reality modeling language that is a standard representing a three-dimensional model and increase efficiency at the time of transmission.

An example of the convergence of broadcasting and communication may include a smart TV. The convergence of broadcasting and communication of fixed type broadcasting has been mixed as various terms such as a smart TV, a connected TV, a web TV, a hybrid TV, or the like.

The convergence services of the fixed broadcasting are switched from a typical TV consumer behavior called lean-back to a consumer behavior called lean-forward. For example, in the lean-back consumer behavior in which the member of family views TV in a living room while comfortably sitting on a sofa or lying on their back to a lean-forward consumer behavior that actively investigates various information through Internet.

An example of the broadcasting communication convergence services may include an Android based smart TV called a Google TV. The smart TV implements the Internet web based services even in TV, which may allow TV to serve as PC. The viewers may use the smart TV to perform the web search or use the social media service in more convenient manner.

In addition, a set top box type TV (referred to as Apple TV) using the smart phone or personal digital assistants (PDA), a hybrid type TV that is a coupling type of the multi-channel broadcasting of the satellite broadcasting and an internet protocol TV (IP TV) video on demand (VOD), and an open hybrid TV (OHTV) that is being currently standardized also provide the broadcasting communication convergence service.

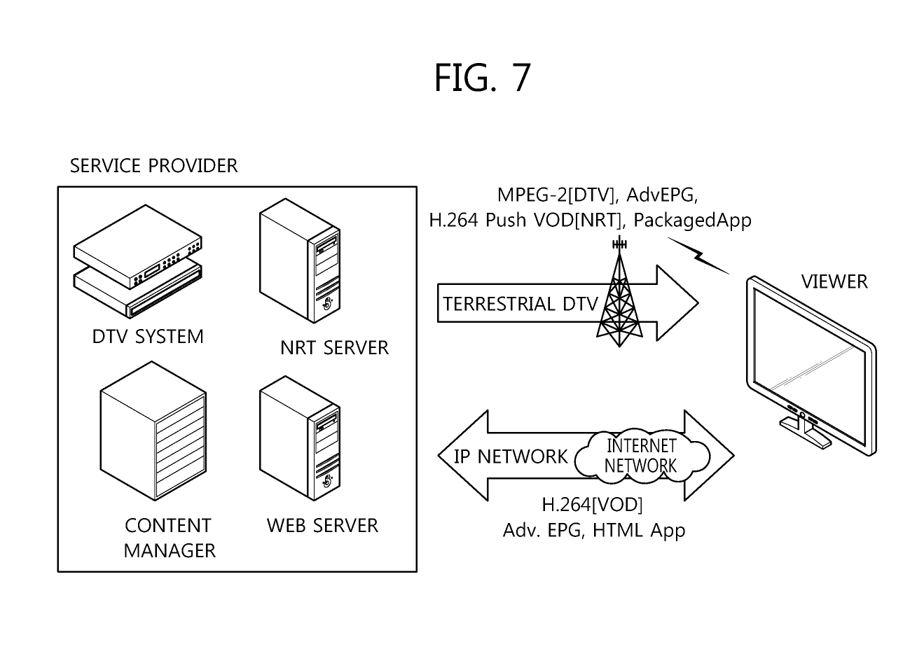

FIG. 7 shows an example of an OHTV system structure.

Referring to FIG. 7, the service provider produces and stores the produced contents through a digital TV (DTV) system, a non real time (NRT) server, a content manager, a web server, or the like, and then, uni-directionally transmits to the service user, that is, the viewer as the terrestrial DTV broadcasting signal (MPEG-2 DTV, Adv.EPG (Advanced Electronic Program Guide), H. 264 Push VOD, or Packaged App (Application)). In this case, a tuner may be used.

In addition, the service provider transmits various additional services (H.264 VOD, Adv EPG, HTML (Hyper Text Markup Language) App) to the service provider through an Internet network (for example, an opened type Internet network). The transmission is the two-way transmission. In this case, the IP network may be used. The viewer, that is, the service user may also transmit the signal to the service provider.

In the OHTV system, the two-way transmission may be performed due to the linking with Internet and may provide the converged type service dominated by the broadcasting station while excluding a cable provider.

The following Table 1 represents features and differences between the OHTV, the connected TV, the smart TV, and the IPTV.

TABLE 1

| | OHTV | Connected TV | Smart TV | IPTV |
|---|---|---|---|---|
| Features | DTV(Real-time | DTV + | DTV + Internet + | Premium network + |
| | broadcasting, | Internet (additional | Application | Internet |
| | Content | service) | | |
| | download) + | | | |
| | Internet(additional | | | |
| | service) | | | |
| Difference | Integrated portal | Dominated by | Dominated by | Dominated by |
| | access | home | Internet | Communication |
| | broadcasting | appliance | Companies | Companies |
| | network and | makers | General viewer as | Communication |
| | Interne associated | General viewer | a target | network subscriber |
| | general viewer as | as a target | Lions issue | as a target |
| | a target | | | |

Referring to Table 1, various TVs introduced in the following Table 1 may provide the broadcasting and communication convergence based service unlike the typical TV and may change services so as to be suited for a variable media consumer behavior in a home.

A method for providing social broadcasting services according to the exemplary embodiments of the present invention will now be described.

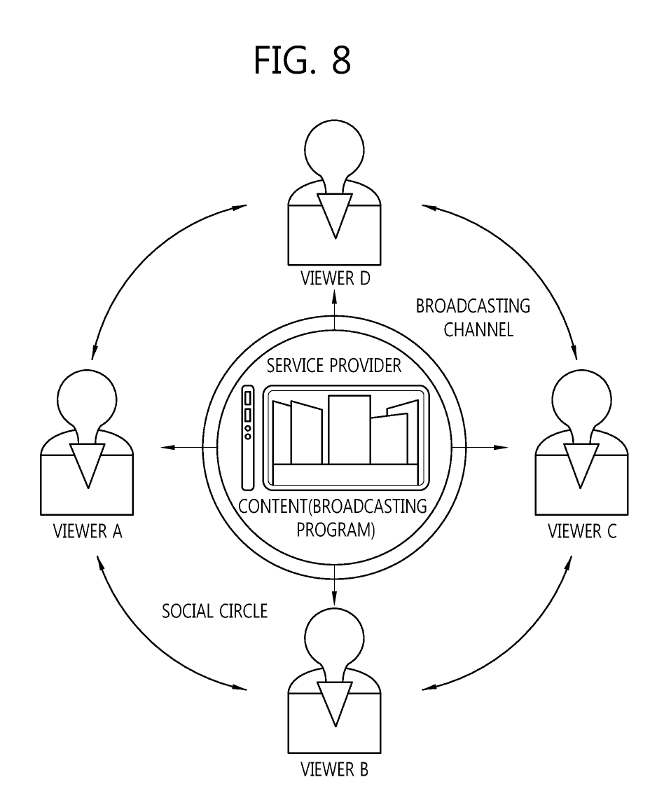

FIG. 8 shows an example of a platform provided by a method for providing social mobile broadcasting services the exemplary embodiments of the present invention.

Referring to FIG. 8, the platform includes a service provider providing broadcasting program contents and a plurality of user equipments. Although user equipment A to user equipment D is shown in the drawing of the present invention, more viewers may be present. In this case, the service provider includes a DMB provider providing the DMB In addition, the user equipment is a equipment including a function of receiving the DMB.

The service provider transmits the contents to the user equipments of the viewers through the broadcasting channel so as to provide the contents to the viewers. The plurality of user equipments configure the social circle. In this case, the social circle is configured based on the broadcasting program (contents) through the mobile broadcasting network. For example, when the group of the user equipments receiving the same broadcasting program (contents) configures the single independent social circle, the user equipments receiving other broadcasting programs belong to different social circles. Further, when the single user equipment receives the plurality of broadcasting programs, the user equipment may belong to the plurality of social circles.

When the programs are transmitted through the mobile broadcasting channel, or the like, the user equipments configuring the social circle may share the reaction information of the viewer (or user) associated with the corresponding broadcasting programs, for example, text information representing the viewer' opinion and thoughts, multimedia data information of audio, video, or the like, or the additional data with other user equipments within the social circle.

In this case, application of the user equipment performing the function of sharing several information between the user equipments within the social circle is called social application. The social application may be social broadcasting application and social circle application.

For example, when the reaction information associated with the broadcasting program is input to the user equipment A by the viewer A through the social application, the user equipment A may create the reaction information as the shared information capable of being shared with other user equipments and transmit the shared information to the service provider. The service provider receiving the shared information may transmit the shared information to other user equipments B, C, and D within the social circle. The user equipments B, C, and D may reproduce or reprocess the shared information to be transmitted to the service provider. As a result, the viewing of the user that does not view the broadcasting program may be derived.

The shared information is aggregated and analyzed in real time by the analysis program of the broadcaster to be used in the program or the target advertising attraction. Moreover, the social activity can help to enlarge the viewing time of the corresponding programs by deriving the unilateral viewing behavior and the positive participation of the user.

For example, the user equipment uses the like function of the DMB BIFS and the facebook application to receive the reaction information of the user and generates the reaction information obtained by the like function as the shared information, thereby providing the social mobile broadcasting services to multiple users. In addition to the BIFS, the web, the flash, and various types of two-way interfaces may be applied.

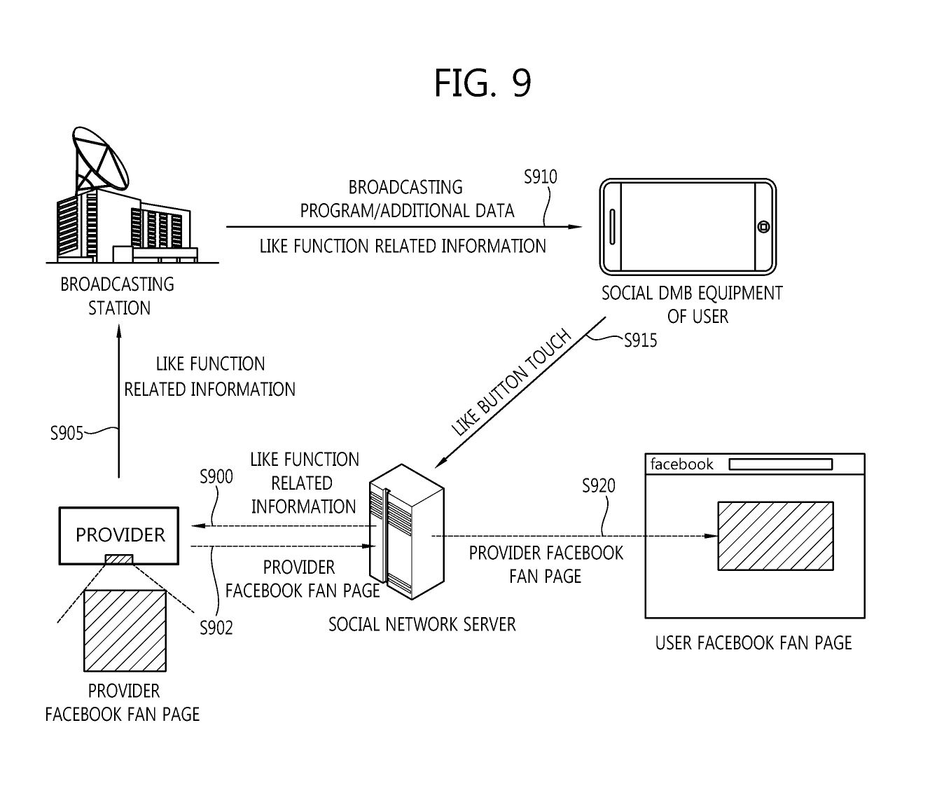

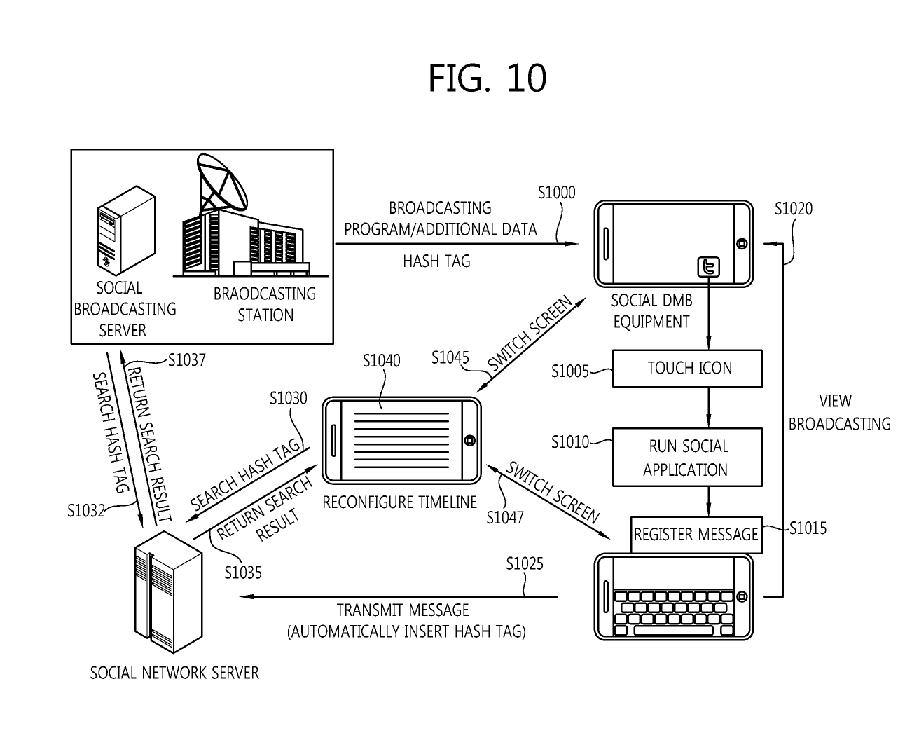

The service provider (for example, broadcasting station of FIG. 9 or 10) transmits BIFS stream and video stream for DMB services to the user equipment. In addition, the service provider may transmit the two-way additional data services to the video screen and various additional data such as image/text/graphic, or the like, to the user equipment through the BIFS stream. In particular, the BIFS stream signal may be synchronized with the video stream signal frame by frame.

For example, when the video stream transmitted by the broadcasting station is a general advertising broadcasting image, the user equipment may use the transmitted BIFS stream so as to be connected with the web page (for example, the facebook fan page of the advertising provider) of the advertising provider associated with the general advertising broadcasting image. For example, a screen touch recognition based user equipment outputs the general advertising broadcasting image and the like image to the screen. When the click or touch of the like image is input by the user, the user equipment may automatically update the broadcasting related content to the user's individual web page (facebook page). The function may be previously set to the user equipment Accordingly, even though the user does not directly search the facebook fan page of the advertising provider and visits his/her own web page, the data regarding the received advertising broadcasting image may be obtained.

The advertising provider may provide the non-exposed information or the additional information in the general advertising broadcasting image to the user equipment through the facebook fan page of the advertising provider. In addition, when the connected facebook page of the advertising provider interlinks with another web page (for example, the user's individual facebook page receiving the general advertising broadcasting image), other users linked with the user's individual facebook page may easily access the facebook page of the advertising provider. As described above, the web page subscriber (for example, the facebook fan page subscriber of the provider) is rapidly expanded and the relation between the user and the provider may be closed based thereon. In addition, the case of the broadcasting image related provider and the contents provider may also be applied similarly.

FIG. 9 is a flow chart showing an example of the social mobile broadcasting service according to the exemplary embodiment of the present invention (embodiment 1). The social mobile broadcasting service is a service in which the broadcasting of the content provider is associated with the web page. Hereinafter, the web page is described as the facebook page using the facebook application. However, the range of the present invention is not limited to the facebook page, but the web page using other types of applications may also be applied.

Referring to FIG. 9, the contents provider (alternatively, service provider, hereinafter, referred to as provider) opening the facebook fan page transmits a code value (or, the like function related information) for performing the like function triggering the transmission of interest indication indicating that the user has an interest in the content provided by the provider to the broadcasting provider (hereinafter, referred to as the broadcasting station) (S905). The like function related information generated by the social network server may be transmitted to the provider (S900).

The broadcasting station transmits the signal including the broadcasting program and the additional data to the user equipment (for example, the social DMB equipment) (S910). In this case, the broadcasting program is transmitted through the video stream and the additional data may be transmitted through the BIFS stream.

In this case, the broadcasting station may transmit the signal in which the like function related information is embedded and may transmit the like function related information to the BIFS stream.

In addition, the broadcasting station may transmit the broadcasting program and the additional data so as to be simultaneously displayed on the screen of the user. The like function related information may be displayed on the screen, in particular, buttons (hereinafter, referred to as like button) performing the like function may be disposed on the screen in the icon form.

An example of the method for triggering the transmission of the interest indicator indicating that the user has an interest in the content (broadcast program content) provided by the provider may include a method of clicking or touching the like button (S915).

When the user triggers the transmission of the interest indicator by clicking or touching the like button in the icon form while viewing the broadcasting program, the social network server links the previously received facebook fan page of the provider with the user's facebook page (S920). The provider facebook fan page may be a page that the provider is previously transmitted to the social network server (S902). Even though the user visits only his/her facebook page, the user may easily access the facebook fan page of the provider. The provider may expose the content related information of the broadcasting program or the additional information such as storytelling information through the facebook fan page of the provider and the user may more easily obtain the additional information.

As described above, the provider facebook page linked with the user facebook page are reproduced as the shared information received by other users within the social circle. The shared information may be connected with other users associated with the users through the network (for example, through the social circle of FIG. 8). Therefore, the consumption of the content can weighted and the program audience rating of the content can be improved. In addition, the increase in the number of corresponding page users has an affirmative effect on the additional advertising profit.

Another example of the exemplary embodiment of the present invention, the social mobile broadcasting services coupled with the twitter application may be provided (embodiment 2). The twitter application may be performed in the smart phone based system and is an example of the social application.

The function of propagating and reproducing the information in real time may be performed through the function of the tweet or the retweet of the twitter function application. The twitter application is one of the social applications to be able to share several information in the member and the tweet is a short message service within 140 letters transmitting other members linked with the user. The retweet means that the users receiving the tweet retransmit the other users linked therewith. Links between the users may be a follow. However, the scope of the present invention is not limited to the twitter application and may also be applied to other kinds of applications that may share the message registered by the user.

The viewer that is viewing the program of the DMB mobile broadcasting, or the like, through the smart phone or the smart TV, or the like, registers the tweet associated with the corresponding program through the twitter applications and then, transmits the registered twitter to the social network server so as to be shared with other users.

In this case, a specific hash tag (#) may be previously set to be automatically inserted into the registered tweet by using the specific field within the broadcasting network, or the like, wherein the hash tag indicates that the tweet transmitted by the viewer is tweet transmitted while viewing the corresponding broadcasting program. As described above, the hash tag is an example of the writing indicator that can be appreciated that the followers of the user receiving the tweet including the hash tag register the tweet while the user viewing the corresponding program. However, the hash tag is an example of the writing indicator and the exemplary embodiment of the present invention is not limited thereto. The scope of the present invention may also be applied to the case in which various types of indicators such as “*”, “&” or “̂” are used.

For example, the tweet into which the hash tag such as “# newsdesk” is inserted is a tweet registered during the receiving of the program called “newsdesk”.

The viewer may prevent the hash tag from being directly registered every times since the hash tag is automatically inserted at the time of registering the related tweet while viewing the broadcasting program.

Meanwhile, in the social application, each of multiple users which are viewing the broadcasting integrates the tweets registered for the program to sequentially configure (or reconfigure) timeline and displays the timeline on the screen of the user equipment to allow the multiple viewers to share tweets with one another, thereby communicating the opinions regarding the program.

FIG. 10 is a flow chart showing another example of social mobile broadcasting services according to another exemplary embodiment of the present invention.

Referring to FIG. 10, the broadcasting provider (hereinafter, referred to as a broadcasting station) transmits the broadcasting program and the additional data to the user equipment through the broadcasting network. The user may be multiple viewers (S1000). Each broadcasting program and additional data include the hash tag that is a unique code and the hash tag may be previously set for each broadcasting program and additional data.

The user equipment (for example, the social DMB user equipment) displays a running (or driving) indicator (button or graphic user interface capable of implementing interaction with the user) indicating the running (or driving) of the twitter application on the video or data service screen receiving the broadcasting program and the additional data.

The user may click the button or touch the GUI of the screen in order to trigger the running indicator (S1005). If the running indicator is triggered to indicate the running, the user equipment runs the twitter application (S1010) and the user may register the message such as the twitter (S1015). After the twitter is registered, the user may again receive the broadcasting program and the additional data (S1020).

In this case, the case in which the user again receives the broadcasting program and the additional data may be simultaneously performed after the twitter application is run or while the twitter applications are run. In this case, the broadcasting viewing and the running of the social applications may be simultaneously performed by using the plurality of social DMB equipments or dividing the screen of the single social DMB equipment into at least two.

The exemplary embodiment of the present invention can transmit the broadcast program inserted into the twitter registered while the user viewing the broadcast program to or the hash tag automatically inserted into the additional data.

In this case, the tweet registered by the user is automatically inserted into the hash tag and is transmitted to the social network server (S1025) and may be displayed on the user twitter page.

Also, the social network server may be receive the tweet from at least one of other user equipments. In addition the broadcasting station may include the social broadcasting server.

The broadcasting station may search whether the tweet includes the hash tag associated with the broadcasting program through the social broadcasting server (S1030). Alternatively, the user equipment of another user or the user equipment of the user may search whether the tweet includes the hash tag associated with the broadcasting program (S1032).

The broadcasting station or the user equipment (or, the equipment of another user) may receive the searched results from the social network server (S1035 and S1037).

Also, the user equipment receiving the searched results may sequentially reconfigure the tweet of at least one of other user equipments including the hash tag (S1040). Also, the reconfigured tweet (or timeline) may be transmitted to the user equipment of other users.

In addition, the user equipment switches the screen so as to switch the reconfigured timeline during the receiving of the broadcasting program (S1045) or may switch the screen so as to view the reconfigured timeline during the running of the twitter application (S1047).

The timeline may be reconfigured based on the tweets received from the user equipments in the social network and may again be transmitted to the user equipment. In addition, the reconfiguration of the timeline may be performed in the separate broadcasting related tweet monitoring/analysis apparatus. The tweet monitoring/analysis apparatus may be responsible for the interlinking of the program registered in the broadcasting station and the hash tag and the general management. The tweet monitoring/analysis apparatus may be included in the broadcasting station.

In addition, when the specific broadcasting program is broadcast at any time, the twitter monitoring/analysis apparatus may perform a search using the hash tag allocated to each broadcast program and collect and process the data associated with the broadcast program from the social network server to provide the twitter service (or timeline).

When the broadcasting station includes the twitter monitoring/analysis apparatus, the broadcasting station manages and links the hash tag associated with the broadcasting program and configures the twitter service session associated with the social network server and the broadcast program, thereby performing the monitoring and control function so as to provide the services.

The social application users may transmit and receive information to and from the viewers that are viewing the corresponding broadcasting program and other users within the social circle in real time while viewing the broadcasting. Therefore, the viewing time of the viewer may be expanded and other users (the followers of the twitter applications) that do not view the broadcasting program may also receive the twitter while the corresponding tweet is registered in the timeline of each user. This may derive the rising effect of the program audience rating that derives the viewing of the program.

In addition, the broadcasting provider aggregates the message such as the tweet, or the like, produced through the social mobile broadcasting applications by the self-analysis system to reflect the needs of the viewer to the program and can collect the important data to attach the associated advertisement or perform the targeted advertisement.

Due to the uni-directional characteristics included in the broadcasting network, there is a problem that it is complicated in allowing a viewer to use a bulletin board of its own web page in order to obtain the feedback data of the viewer and log the broadcasting station web page in a personal computer in order to transmit his/her own intention and leave writing and it is difficult to immediately transfer the intention.

However, in the social DMB broadcasting coupling the characteristics of the real-time broadcasting content with the characteristics of the real-time twitter, the broadcasting provider can easily obtain the user related data and the processes the user related data, thereby providing more advantageous services to the users.

As set forth above, the exemplary embodiments of the present invention can simultaneously implement advantages of broadcasting and advantages of wireless Internet.

Further, the exemplary embodiments of the present invention can share the personal's opinion and thoughts and the additional data associated with the corresponding programs through the social circle while the user viewing the broadcasting programs in real time during the movement.

Also, the exemplary embodiments of the present invention can derive the program viewing by the reproduction/reprocessing processes by propagating the information associated with the broadcasting programs to the plurality of users/viewers within the corresponding social circle in real time while permitting the user/viewer to directly produce the information associated with the broadcasting programs.

In addition, the exemplary embodiments of the present invention can aggregate and analyze the information associated with the broadcasting programs in real time by the provider's analysis program to use the information in the program or the target advertising attraction.

Moreover, the exemplary embodiment of the present invention can help to enlarge the viewing time of the corresponding programs by deriving the positive participation of the user through the social activity.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A method of a broadcasting station for providing social broadcasting services, comprising:
receiving like function related information triggering transmission of an interest indicator indicating that a user of a user equipment has an interest in broadcasting programs provided by a content provider; and
transmitting both of the broadcasting programs and additional data including the like function related information to the user equipment.

2. The method of claim 1, wherein the broadcasting programs are transmitted to the user equipment through a video stream and the additional data are transmitted to the user equipment through a binary format for scene (BIFS) stream.

3. The method of claim 2, wherein a signal of the video stream and a signal of the BIFS stream are synchronized with each other frame by frame.

4. The method of claim 1, wherein the like function related information is information set so as to position in an icon form buttons performing the like function on a screen of the user equipment to which the broadcasting programs are provided and trigger the transmission of the interest indicator when the icons are clicked or touched.

5. The method of claim 1, wherein the interest indicator indicates so as to allow the user equipment to run social application of the user equipment.

6. The method of claim 5, wherein the social application is facebook application so as to share a web page including information regarding the broadcasting programs with other user equipments.

7. A method of a user equipment for providing social broadcasting services, comprising:
receiving from a broadcasting station additional data including like function related information triggering transmission of an interest indicator indicating that a user of the user equipment has an interest in broadcasting programs provided by a content provider, together with the broadcasting programs;
to running a social application of the user equipment when the transmission of the interest indicator is triggered; and
linking a web page of the content provider with a web page of the user by using the social application.

8. The method of claim 7, wherein the social application is facebook application so as to share the web page including information regarding the broadcasting program with other user equipments, and
the web page of the content provider and the web page of the user each are the facebook page of the content provider and the facebook page of the user.

9. The method of claim 7, wherein the broadcasting program is received from the broadcasting station through a video stream and the additional data are received through a BIFS stream from the broadcasting station.

10. The method of claim 9, wherein a signal of the video stream and a signal of the BIFS stream are synchronized with each other frame by frame.

11. The method of claim 7, wherein the like function related information is information set so as to position in an icon form buttons performing the like function on a screen of the user equipment to which the broadcasting programs are provided and trigger the transmission of the interest indicator when the icons are clicked or touched.

12. A method of a broadcasting station for providing social broadcasting services, comprising:
receiving from a social network server a writing indicator indicating that a message registered using social application by a user of a user equipment is a message regarding broadcasting programs provided by a content provider; and
transmitting both of additional data including the writing indicator and the broadcasting programs to the equipment.

13. The method of claim 12, wherein the broadcasting programs are transmitted through a video stream and the additional data are transmitted through the BIFS stream.

14. The method of claim 13, wherein a signal of the video stream and a signal of the BIFS stream are synchronized with each other frame by frame.

15. The method of claim 12, wherein the social application is twitter application so as to share a message registered by the user equipment with other user equipments, and the message registered by the user equipment is a tweet.

16. A method for providing social broadcasting services by a user equipment, comprising:
receiving from a broadcasting station additional data including a writing indicator indicating that a message registered using social application by a user of a user equipment is a message regarding broadcasting programs provided by a content provider, together with the broadcasting programs;
displaying the broadcasting programs so as to represent a running indicator indicating a running of the social application on a screen of the broadcasting programs;
running the social application when the running indicator is triggered;
registering a message using the social application; and
attaching the writing indicator to the registered message so as to be transmitted to a social network server.

17. The method of claim 16, wherein the social network server receives the message from at least one user equipment, searches whether the message includes the writing indicator, transmits whether the message includes the writing indicator to at least one user equipment, sequentially configures a timeline for a message of the at least one user equipment including the writing indicator, or transmits the configured timeline to the user equipment of the user.

18. The method of claim 16, wherein the running indicator is set so as to be position on the screen of the equipment to which the broadcasting programs are provided in an icon form or a graphic user interface (GUI) and to trigger the transmission of the running indicator when the icon or the GUI is clicked or touched.

19. The method of claim 16, further comprising:
sequentially reconfiguring a timeline for the message registered during the viewing of the broadcast program using the social application; and
displaying the timeline on a screen.

20. The method of claim 19, further comprising:
receiving a message registered while at least one of other user equipments are viewing the broadcast programs from the social network,
wherein the timeline are sequentially reconfigured together with a message registered by at least one of other user equipments.
